(19) United States
(12) Patent Application Publication
(10) Pub. No.: US 2018/0010356 A1
(43) Pub. Date: Jan. 11, 2018

(54) Self-Illuminated Portable Shadowbox Monument

(71) Applicant: J. Daniel Faulkner, Hoschton, GA (US)

(72) Inventor: J. Daniel Faulkner, Hoschton, GA (US)

(21) Appl. No.: 15/204,098

(22) Filed: Jul. 7, 2016

(51) Int. Cl. E04H 13/00; F21S 9/03; G09F 13/18; G09F 1/12; A47F 3/00

(52) U.S. Cl. CPC E04H 13/003; G09F 1/12; A47F 3/00; G09F 13/18; F21S 9/037; F21Y 2115/10; G09F 2013/1881

(57) ABSTRACT

A self-illuminated shadow box for containing mementos or the like includes a box that has an upright metallic back wall panel for attaching magnets, a transparent door spaced from the upright metallic back wall panel, a roof extending over the metallic back wall panel and the transparent wall, and a solar energized light emitting diode mounted on the roof and directed toward the metallic back wall.

### BACKGROUND OF THE INVENTION

Cemeteries in the U.S.A. allow family members to place flowers at the graves of loved ones, showing the love and care of the survivors. Some of the flowers are artificial and tend to have a longer life than natural flowers. Also, some written messages are left at grave sites, such as prayers, photographs or letters to the deceased. In some instances, the messages left are for the benefit of others viewing the gravesite.

### SUMMARY OF THE INVENTION

This invention concerns a monument that can be placed at the gravesite of a loved one or of a friend or of a famous person, with a picture or prayer or other message, with the monument being formed so as to conveniently change the message from time to time. Further, this invention concerns a monument in the form of a shadow box that may be placed at the gravesite, with a self-actuated light emitting diode supported by the shadowbox for emitting light toward the space where the message would be placed in the shadowbox. The light emitting diode may be solar energized so that an electrical source other than the sun is not needed to light the shadow box.

Further, the shadow box is formed in a configuration that maintains its interior substantially closed and moisture free from most rain and other environmental conditions and that would not likely be opened by accident.

Thus, it is an object of this invention to provide a self-illuminated shadowbox monument for use in cemeteries and other outdoor places, whereby messages and other items may be placed in the shadow box, with the means for illuminating the message in the time of atmospheric darkness.

### BRIEF DESCRIPTION OF THE DRAWINGS

FIG. 1 is a front view of a shadowbox monument, including a message placed in the shadow box, and flowers positioned about the support of the shadow box.

FIG. 2 is a perspective view of the shadow box of FIG. 1, but with the flowers removed.

FIG. 3 is a front view of the shadow box with the door closed and without the support post.

FIG. 4 is a side view of the shadow box of FIG. 3, with the door closed.

FIG. 5 is a perspective view of the shadow box with the door open, and with a written message and picture inside the box, that is typical of the use of the shadow box at a grave site.

FIG. 6 is a perspective view of the shadow box showing the transparent door closed and the contents of the shadow box visible through the door.

### DETAILED DESCRIPTION

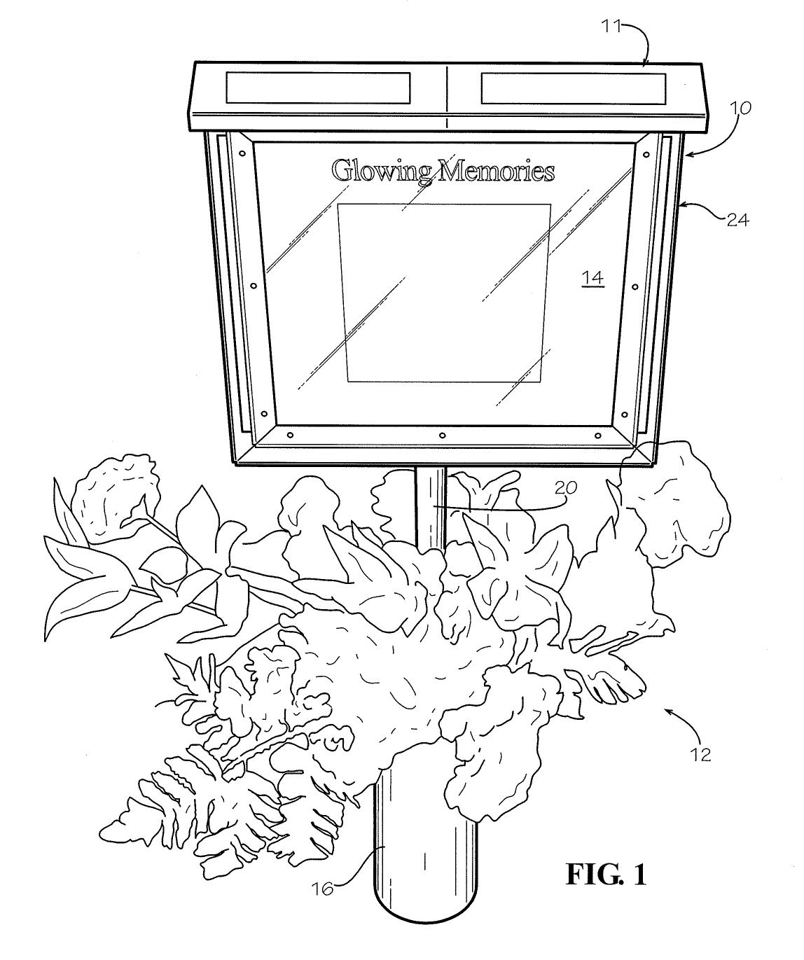

Referring now in more detail to the drawings in which like numerals indicate like parts throughout the several views, FIG. 1 illustrates a self-illuminated portable shadow box monument 10 that may include decorative flowers 12 outside a shadow box 11, and pictures and messages 14 may be placed in the shadow box.

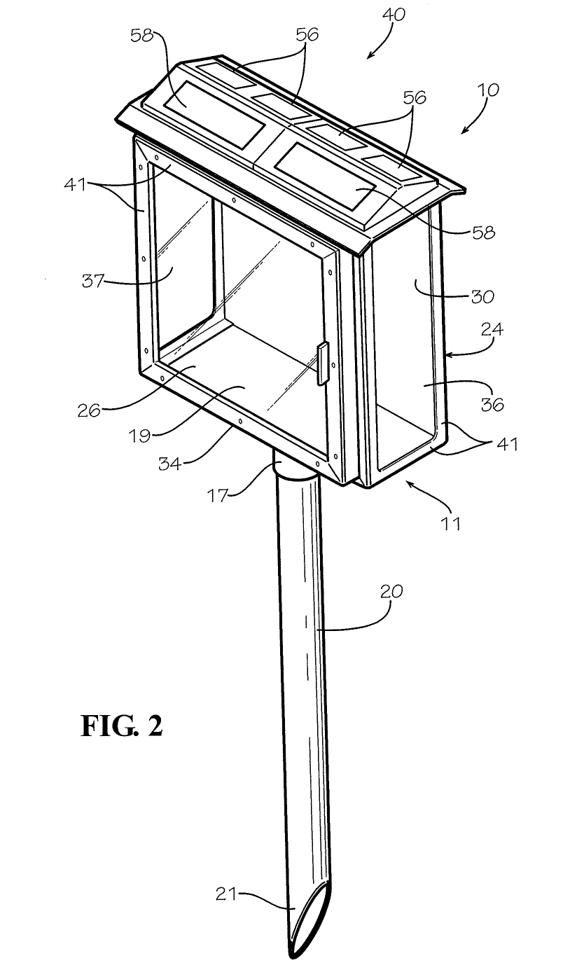

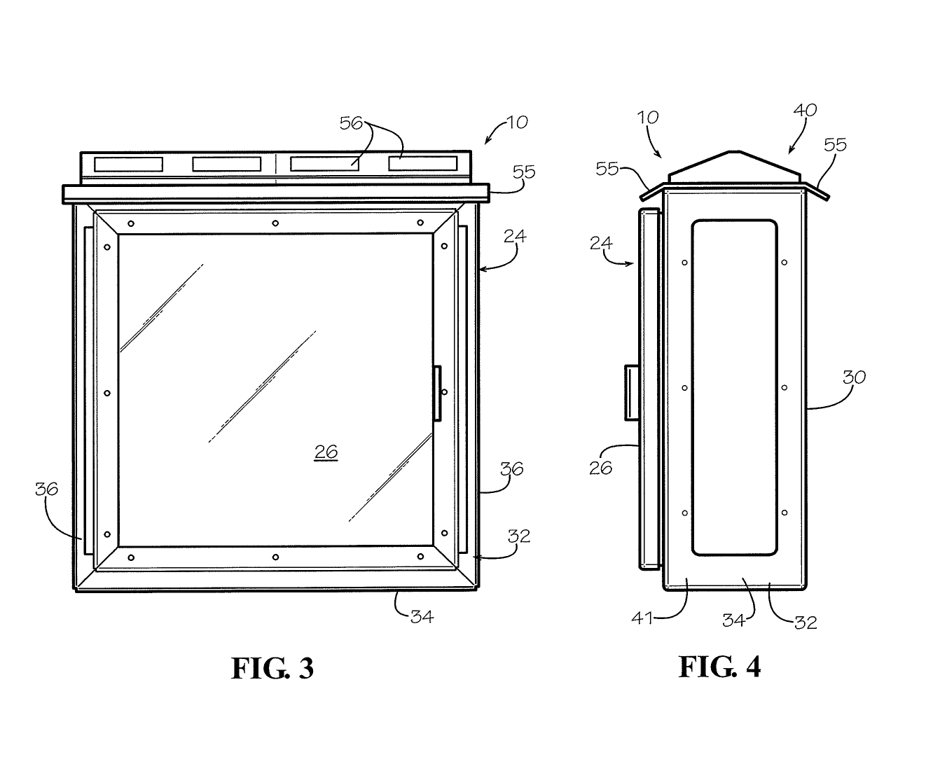

As shown in FIG. 2, the shadow box monument 10 includes a shadow box 11, its support such as support tube 20 that is cylindrical in cross section and is to be positioned in an upright attitude with an open top fitted into a support socket 17 that is rigidly mounted to the bottom wall 19 of the shadow box. The bottom end 21 of the support tube may be formed at an angle to penetrate the ground or be inserted into a receptacle, not shown, that rests on the ground.

When the support tube is inserted into the ground the angled bottom end reduces the likelihood of the shadow box 11 being accidentally rotated in the earth, so that the shadow box remains facing the direction that it faced upon initial placement.

However, if the support tube is to be placed on a floor or other horizontal impermeable surface, the bottom of the support tube may be positioned on a stand 16 such as shown in FIG. 1 that has an upwardly facing socket, similar to the support socket 17, to receive the tube 16. For example, FIG. 1 shows the support tube 20 made of heavy rigid material to stabilize the shadow box.

As shown in FIG. 2, the shadow box 24 includes a framework 41 that forms the support for a thin rectangular shape of the box. Flat panels are supported at their edges by the framework. The upright metallic back panel 30 is parallel to the upright transparent door 26 when the door is in its closed position that closes the shadow box. The box also includes opposed upright side walls 36 and 37 and the horizontal bottom wall 19.

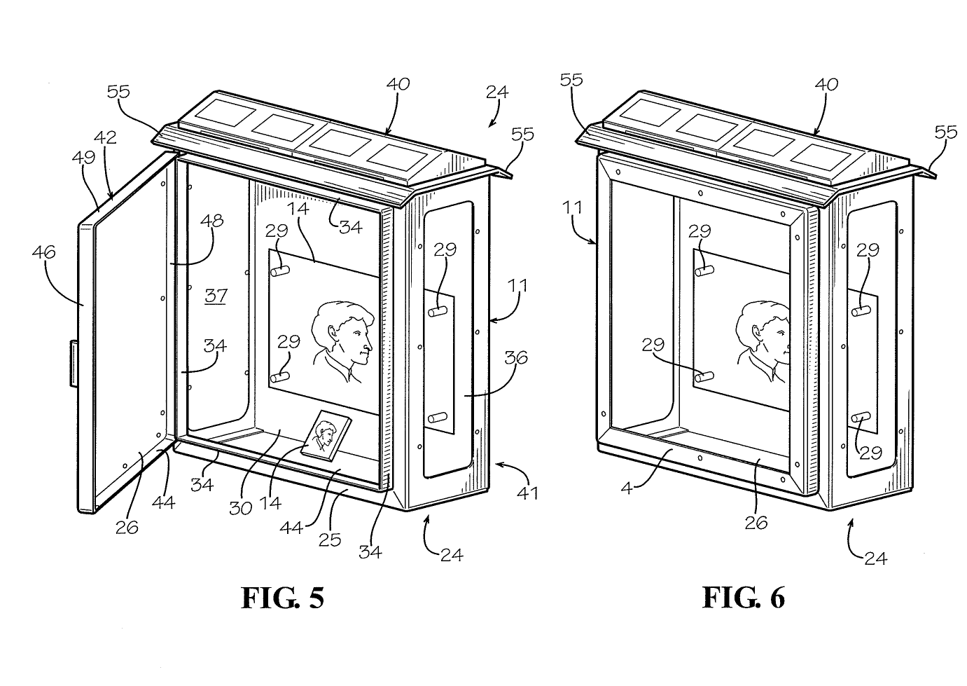

As shown in FIG. 5, the upright back wall 30 may be made of ferrous metal that would support magnets 29 that can be used to maintain pictures and messages on the back wall. The back wall is a small distance from the upright transparent door when the door is in its closed position, as shown in FIG. 6. This small distance, about two inches, usually provides adequate room for posting messages and pictures in the shadow box and it makes the messages and pictures easier to read when viewing through the transparent door.

The narrow side walls 36 and 37 may be formed of transparent sheet material, as shown. This arrangement usually induces a person to view the contents of the shadow box messages or pictures 14 from the front of the shadow box, through the transparent door 26 to where the contents have been arranged for viewing. This also tends to control the position of the viewer to be positioned at the transparent door when reading the message in the shadow box, so the shadow box can be positioned adjacent a pedestrian path and the items in the shadow box reviewed while the reader stays in a desired location, such as on a path in a cemetery.

As shown in FIGS. 2 and 4, the top wall or “roof” 40 of the shadow box is formed in an inverted V-shape with light emitting diodes (LED's) 58 powered by photovoltaic cells (PVC's) 56 in translucent photovoltaic glass panels. Preferably, the LEDs are positioned in the roof 40 on the side of the roof that has more direct exposure to the upright metallic back wall 30 and its message and/or picture 14 posted on the back wall. The solar collectors 56 are positioned in the other glass panels of the other sloped section of the roof.

The transparent door 26 may be formed of molded acrylic material that is transparent. As shown in FIGS. 5 and 6, the door 26 includes a perimeter rim 42 that has a horizontal bottom flange 44, upright side flanges 46 and 48, and horizontal top flange 49. The door frame 25 surrounds the door opening and includes a frame flange 34 that extends away from the interior of the shadow box. The frame flange 25 is sized and shaped to match the size and shape of the door 26, so when the door is moved toward its closed position, it telescopically nests with the perimeter rim of the door, thereby substantially sealing the door to its opening and retarding the entry of moisture into the interior of the shadow box. The tight fit of the door to the frame of the shadow box also reduces the likelihood that insects would enter the interior of the shadow box.

Roof shields 55 form an extension of the roof 40 so that the roof extends from the edges of the framework 41 to divert rain from the shadow box.

Messages, pictures and other articles 14 may be placed in the shadow box 24 on the metal back wall 30 or on the bottom wall 44 and magnets 29 may be placed against the messages and pictures to hold them against the metal back wall. If magnets are not available, adhesive connectors (not shown) may be used.

The transparent door can then be closed to mount about the frame flange 34 of the shadow box. A conventional handle (not shown) may be used to hold the transparent face plate in its closed position. This locates the vertical walls and door of the shadow box under the overhang of the roof 40 and roof shields 55 so that rain usually does not enter the interior of the shadow box.

Although a preferred embodiment of the invention has been disclosed in detail herein, variations and modifications of the disclosed invention may be made without departing from the spirit and scope of the invention as set forth in the following claims.

1.-6. (canceled)

7. A self-illuminated shadowbox for containing mementos or the like comprising
an upright metallic back wall panel for attaching magnets,
a transparent door spaced from the upright metallic back wall panel,
a roof extending over the metallic back wall panel and over the transparent door, and
a solar energized light emitting diode mounted on the roof and directed toward the metallic back wall.

8. The self-illuminated shadowbox of claim 7, and further including a plurality of magnets for holding a paper bearing a message against the back wall of the shadowbox.

9. The self-illuminated shadowbox of claim 7, and further including a rectilinear framework that forms the shape of the shadowbox panels.

10. A self-illuminated monument for marking a grave or the like comprising
a shadowbox that includes an upright metallic back wall panel for supporting magnets,
a transparent door opposed to and spaced from the upright metallic back wall panel for closing the shadowbox,
an inverted V-shaped roof including a first roof panel extending over the transparent door and facing the metallic back wall panel, and a second roof panel extending over the back wall panel,
a solar energized light emitting diode mounted on the first roof panel of the inverted V-shaped roof and directed toward the metallic back wall.

11. The self-illuminated monument of claim 10, wherein the shadowbox and its transparent door include flanges that nest together when the door is closed.

12. The self-illuminated monument of claim 10, wherein the inverted V-shaped roof overhangs the metallic back wall panel and the transparent door.

13. The self-illuminated monument of claim 10, and further including a post for mounting to the shadowbox.

14. The self-illuminated monument of claim 10, and further including magnets for posting paper objects to the upright metallic back wall panel.
